(19) United States
(12) Patent Application Publication
(10) Pub. No.: US 2025/0244253 A1
(43) Pub. Date: Jul. 31, 2025

(54) INSPECTION ASSISTANCE SYSTEM AND INSPECTION ASSISTANCE METHOD

(71) Applicant: SUMITOMO HEAVY INDUSTRIES, LTD., Tokyo (JP)

(72) Inventor: Shintaroh SUGIMOTO, Yokosuka-shi (JP)

(21) Appl. No.: 19/000,662

(22) Filed: Dec. 23, 2024

(30) Foreign Application Priority Data
Jan. 25, 2024 (JP) 2024-009160

(51) Int. Cl. G01N 21/88; G01N 21/958

(52) U.S. Cl. CPC G01N 21/8806; G01N 21/958; G01N 2201/068

(57) ABSTRACT

An inspection assistance system includes: an imaging unit configured to image an inspection object; an irradiation unit disposed between the imaging unit and the inspection object to irradiate the inspection object with light; a light-blocking unit disposed between the irradiation unit and the inspection object and having a light-blocking region that blocks the light and a light transmission region that transmits the light; and an irradiation light control unit configured to control the light emitted to irradiate the inspection object by changing a position of the light transmission region in the light-blocking unit.

### CROSS-REFERENCE TO RELATED APPLICATIONS

This application claims priority to Japanese Patent Application No. 2024-009160, filed on Jan. 25, 2024, which is incorporated by reference herein in its entirety.

### BACKGROUND

### Technical Field

A certain embodiment of the present invention relates to an inspection assistance system and an inspection assistance method.

### Description of Related Art

A technique is known in which a transparent or semi-transparent injection molding product, which is an inspection object, is imaged, and a defect of the injection molding product is emphasized and displayed on a captured image of the injection molding product (for example, the related art). In this technique, the defect of the inspection object is emphasized by irradiating the inspection object with light output from irradiation means when the inspection object is imaged.

### SUMMARY

According to an embodiment of the present invention, there is provided an inspection assistance system including: an imaging unit configured to image an inspection object; an irradiation unit disposed between the imaging unit and the inspection object to irradiate the inspection object with light; a light-blocking unit disposed between the irradiation unit and the inspection object and having a light-blocking region that blocks the light and a light transmission region that transmits the light; and an irradiation light control unit configured to control the light emitted to irradiate the inspection object by changing a position of the light transmission region in the light-blocking unit.

Here, the light-blocking unit may include one or a plurality of cutout portions or penetrating portions as the light transmission region.

In addition, the irradiation unit may have a substantially annular shape when viewed from the inspection object, and the light-blocking unit may be a substantially annular member provided with the light transmission region, which has the same or substantially the same shape as the irradiation unit.

In addition, the light-blocking unit may rotate in a circumferential direction to change the position of the light transmission region.

In addition, at least one of the irradiation unit and the light-blocking unit may be movable in an axial direction.

In addition, the light-blocking unit may include the light transmission region and one or more additional light transmission regions that enable switching between an exposed state and a non-exposed state.

In addition, the inspection object may be a transparent or semi-transparent injection molding product.

In addition, according to an embodiment of the present invention, there is provided an inspection assistance method including: a step of causing an imaging unit to image an inspection object; a step of causing an irradiation unit disposed between the imaging unit and the inspection object to irradiate the inspection object with light; a step of causing a light-blocking region of a light-blocking unit disposed between the irradiation unit and the inspection object to block the light and causing a light transmission region of the light-blocking unit to transmit the light; and a step of causing an irradiation light control unit to control the light emitted to irradiate the inspection object by changing a position of the light transmission region in the light-blocking unit.

### BRIEF DESCRIPTION OF THE DRAWINGS

FIG. 1 is a diagram illustrating an example of an overall configuration of an inspection assistance system according to the present embodiment.

FIGS. 2A to 2C are diagrams illustrating specific examples of shapes of an irradiation unit and a light-blocking member.

FIG. 3 is a diagram illustrating a specific example of an imaging method during an internal inspection for an inspection object.

FIGS. 4A and 4B are diagrams illustrating a modification example of the light-blocking member.

FIG. 5 is a diagram illustrating an example in which an illumination tool is projected onto the inspection object and appears on a captured image when the inspection object is imaged.

### DETAILED DESCRIPTION

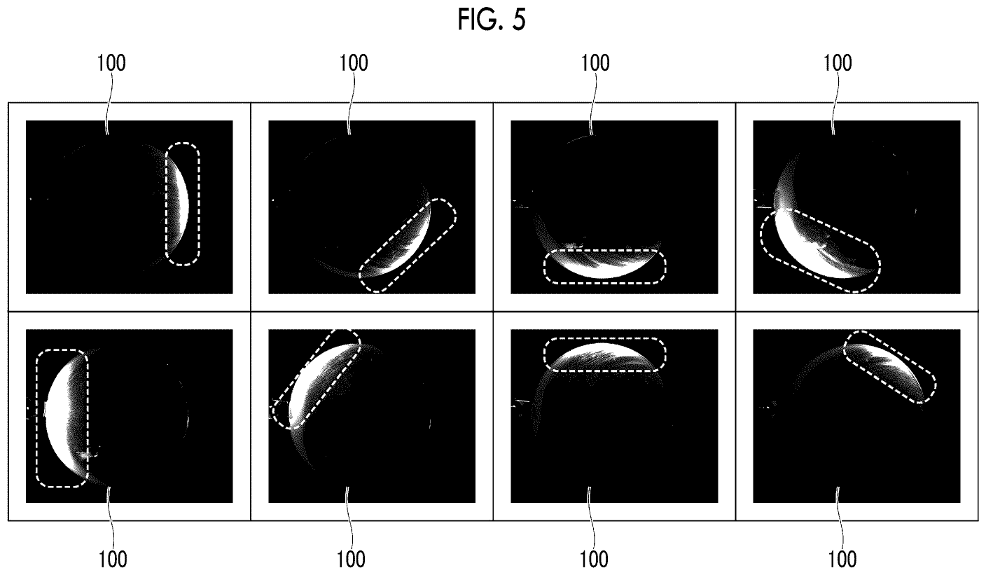

Light output from an illumination tool when the inspection object is imaged may be reflected on the inspection object, and may appear in the captured image, which may hinder an inspection. Furthermore, depending on a material or a surface processing mode of the inspection object, the illumination tool projected onto the inspection object when the inspection object is imaged may appear in the captured image, which may hinder the inspection (for example, refer to FIG. 5). In contrast, for example, when outputs from a plurality of light sources having different irradiation angles are switched, it is possible to suppress an appearance of the light reflected on the inspection object or an appearance of the illumination tool projected onto the inspection object. However, costs for providing the plurality of light sources and means for controlling each output of the plurality of light sources having the different irradiation angles are required.

It is desirable to realize a simpler method for suppressing an appearance of light reflected on an inspection object and an appearance of irradiation means projected onto the inspection object when the inspection object is imaged, compared to when a plurality of light sources having different irradiation angles are provided to image the inspection object.

Hereinafter, embodiments of the present invention will be described in detail with reference to the accompanying drawings.

### Configuration of Inspection Assistance System 1

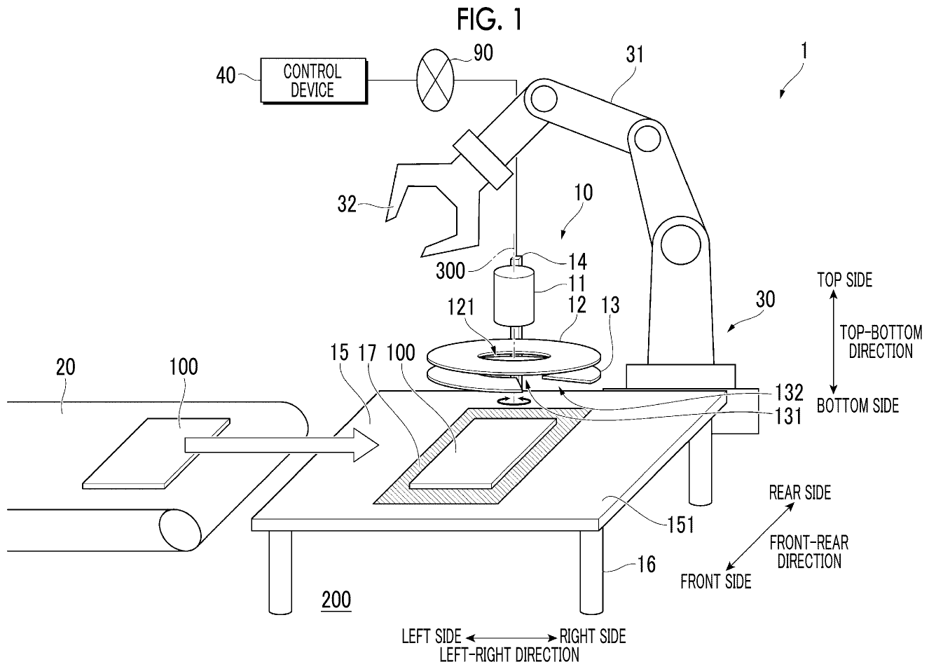

FIG. 1 is a diagram illustrating an example of an overall configuration of an inspection assistance system 1 according to the present embodiment.

The inspection assistance system 1 illustrated in FIG. 1 is a system used for a quality inspection of a transparent or semi-transparent injection molding product 100. The injection molding product 100 is manufactured by an injection molding machine (not illustrated), and a shape thereof is not particularly limited. The inspection object of the quality inspection in the present embodiment is an injection molding product having a transparent or semi-transparent flat plate shape. The injection molding machine is a device that can manufacture the injection molding product 100 by pouring a transparent or semi-transparent resin melted by heating into a mold, solidifying the resin by cooling, and thereafter extracting the solidified resin.

The inspection assistance system 1 includes an imaging device 10 that images the injection molding product 100 serving as the inspection object, a conveying device 20 that conveys the injection molding product 100, a picking device 30 that grips and moves the injection molding product 100, and a control device 40 that determines whether or not the injection molding product 100 has a defect. The imaging device 10 and the control device 40 are connected to each other via a network 90. For example, the network 90 is a local area network (LAN), the Internet, a wired connection, or the like. At least one of the conveying device 20 and the picking device 30 may be connected to the network 90.

FIG. 1 illustrates a state where the injection molding product 100 serving as an inspection target conveyed by a conveying device 20 is imaged by the imaging device 10. A direction in which the imaging device 10 images the injection molding product 100 is a direction from an upper side (top side) to a lower side (bottom side) in an up-down direction in the drawing of FIG. 1 which indicates a top-bottom direction. In addition, a direction in which the conveying device 20 conveys the injection molding product 100 is a direction from a left side to a right side in a left-right direction in the drawing of FIG. 1. In addition, in directions horizontally perpendicular to the left-right direction in the drawing, a “front-rear direction” illustrated in FIG. 1 is defined such that a front side in the drawing is a “front side” of the imaging device 10, and a rear side in the drawing is a “rear side” of the imaging device 10.

### Imaging Device 10

The imaging device 10 includes an imaging unit 11 as imaging means for imaging the injection molding product 100 serving as the inspection object, an irradiation unit 12 as irradiation means for irradiating the injection molding product 100 serving as an imaging target with light, and a light-blocking member 13 as light-blocking means for blocking some of the light emitted to irradiate the injection molding product 100 from the irradiation unit 12. In addition, the imaging device 10 includes a support member 14 that supports the imaging unit 11, the irradiation unit 12, and the light-blocking member 13, a support member 15 that supports the injection molding product 100 from the bottom side in the top-bottom direction with respect to the injection molding product 100, four support members 16 that support the support member 15 from the bottom side in the top-bottom direction with respect to the support member 15, and an underlay member 17 disposed between the injection molding product 100 and the support member 15.

The imaging unit 11 includes a camera capable of imaging a still image or a moving image, and images the injection molding product 100 serving as the inspection object, as an imaging subject. Specifically, the imaging unit 11 images the injection molding product 100 irradiated with the light output by the irradiation unit 12 from the top side toward the bottom side in the top-bottom direction. The imaging unit 11 transmits a captured image of the injection molding product 100 to the control device 40. The camera forming the imaging unit 11 is not particularly limited. For example, the camera includes a monochrome camera, a color camera, a polarization camera, or the like. The polarization camera is a camera in which polarizers having different directions are incorporated on a charge-coupled device (CCD) or a complementary metal-oxide-semiconductor (CMOS).

The irradiation unit 12 is an annular illumination tool having a penetrating portion 121 having a circular shape or a substantially circular shape that penetrates a central portion in the top-bottom direction. The irradiation unit 12 is not divided into a plurality of light sources having different irradiation angles. The irradiation unit 12 is disposed on the top side in the top-bottom direction with respect to the injection molding product 100 serving as the inspection object, and on the bottom side in the top-bottom direction with respect to the imaging unit 11. The irradiation unit 12 is movable in the top-bottom direction along the support member 14. A method for moving the irradiation unit 12 along the support member 14 is not particularly limited. For example, a drive unit such as a motor may be provided in the support member 14 to control the movement of the irradiation unit 12 in the top-bottom direction, or the irradiation unit 12 may be manually moved.

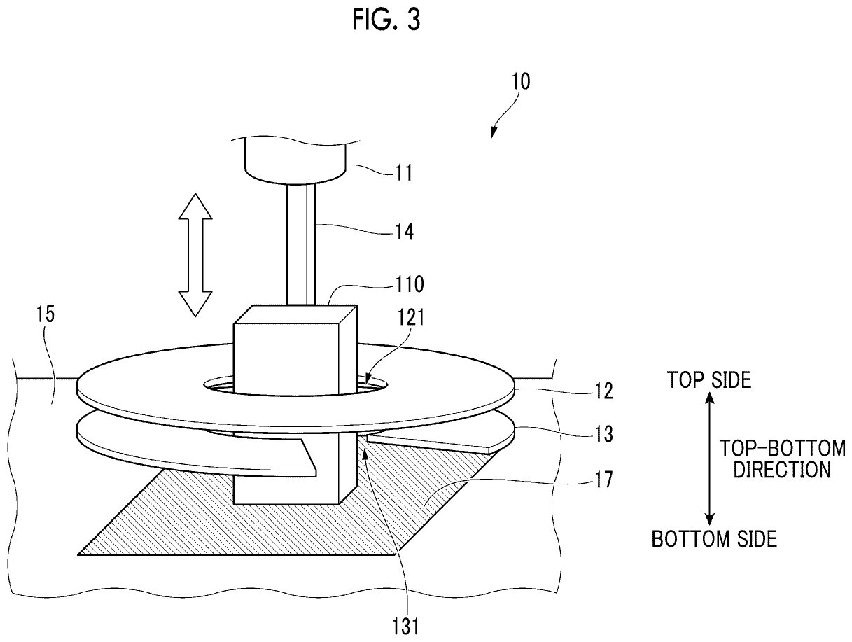

The penetrating portion 121 formed in the irradiation unit 12 forms an imaging space for preventing an appearance of the irradiation unit 12 as much as possible when the injection molding product 100 is imaged. The light emitted to irradiate the injection molding product 100 from the irradiation unit 12 includes light used for irradiating the injection molding product 100 from the top side toward the bottom side in the top-bottom direction, and the imaging of the imaging unit 11 is assisted by the irradiation light. A size of a diameter of the irradiation unit 12 or a size of a diameter of the penetrating portion 121 is not particularly limited, and can be changed depending on a size or a shape of the inspection object. Specific examples of the irradiation unit 12 will be described later with reference to FIG. 3.

The light-blocking member 13 is a member disposed on the top side in the top-bottom direction with respect to the injection molding product 100 and on the bottom side in the top-bottom direction with respect to the irradiation unit 12, and blocks some of the light emitted to irradiate the injection molding product 100 from the irradiation unit 12. The light-blocking member 13 includes a substantially annular light-blocking member having a cutout portion 132. The cutout portion 132 forms a region (hereinafter, referred to as a “light transmission region”) that transmits the light emitted to irradiate the injection molding product 100 from the irradiation unit 12.

A substantially circular space 131 is formed in a central portion of the light-blocking member 13. As in the penetrating portion 121 formed in the above-described irradiation unit 12, the space 131 forms an imaging space for preventing an appearance of the light-blocking member 13 as much as possible when the injection molding product 100 is imaged. A material of the light-blocking member 13 is not particularly limited as long as the light-blocking member 13 can block the light emitted from the irradiation unit 12. For example, the light-blocking member 13 may be formed of metal, a resin, a thick paper, or the like. The shape of the light-blocking member 13 can be changed depending on the size of the diameter of the irradiation unit 12, the size of the diameter of the penetrating portion 121 of the irradiation unit 12, the size or the shape of the inspection object, or the like.

The light-blocking member 13 transmits some of the light emitted to irradiate the inspection object from the irradiation unit 12 toward the injection molding product 100 through the cutout portion 132 which is the light transmission region, and blocks the remaining light. When a position of the cutout portion 132 is changed, an application of the light emitted to irradiate the injection molding product 100 is changed. Specific examples of the shape of the light-blocking member 13 and the shape or the position of the cutout portion 132 formed in the light-blocking member 13 will be described later with reference to FIG. 3.

The light-blocking member 13 is movable in the top-bottom direction along the support member 14. Here, the light-blocking member 13 may move in the top-bottom direction in conjunction with the movement of the irradiation unit 12 in the top-bottom direction, or may move in the top-bottom direction independently of the irradiation unit 12. A method for moving the light-blocking member 13 in the top-bottom direction is not particularly limited. For example, a drive unit such as a motor may be provided in the support member 14 to control the movement of the light-blocking member 13 in the top-bottom direction, or the light-blocking member 13 may be manually moved.

In addition, the light-blocking member 13 is rotatable in a circumferential direction. When the light-blocking member 13 rotates in the circumferential direction, the position of the cutout portion 132 serving as the light transmission region is changed, and as a result, the application of the light emitted to irradiate the injection molding product 100 is changed. A method for rotating the light-blocking member 13 in the circumferential direction is not particularly limited. For example, a drive unit such as a motor may be provided in the support member 14 to control the rotation of the light-blocking member 13 in the circumferential direction, or the light-blocking member 13 may be manually rotated in the circumferential direction.

The support member 14 is a member that supports the imaging unit 11, the irradiation unit 12, and the light-blocking member 13, and includes a rod-shaped member extending in the top-bottom direction, or the like. A portion of the support member 14 on the bottom side in the top-bottom direction is fixed to the support member 15 or an installation surface 200. A method for fixing the support member 14 to the support member 15 or the installation surface 200 is not particularly limited, and the support member 14 is fixed by using a bolt or the like, for example. The support member 14 supports each of the irradiation unit 12 and the light-blocking member 13 to be movable in the top-bottom direction. In addition, the support member 14 supports the light-blocking member 13 to be rotatable in the circumferential direction of the light-blocking member 13.

The support member 15 is a rectangular plate material for placing the injection molding product 100 when the injection molding product 100 is imaged by the imaging unit 11, and is a support member that supports the injection molding product 100 from the bottom side on a top side surface 151 in the top-bottom direction. The support member 15 includes an opaque member such as a metal plate material and a wooden plate material. The support member 15 is fixed to the installation surface 200 such as a floor surface in a state of being supported by four support members 16 including a substantially columnar member or the like from the bottom side in the top-bottom direction.

The shape of the support member 16 is not particularly limited. In addition, a method for fixing the support member 16 to the installation surface 200 is not particularly limited, and the support member 16 is fixed to the installation surface 200 by a bolt or the like, for example. Furthermore, the support member 16 does not necessarily need to be fixed to the installation surface 200 as long as stability can be ensured during imaging. Therefore, for example, a combination of the support member 15 and the four support members 16 may be a combination of a top plate and four legs which form a stable inspection table.

The underlay member 17 is a sheet-shaped member disposed between the injection molding product 100 and the support member 15. The underlay member 17 includes a member having a light-blocking function such as vinyl chloride or a flocked paper, and assists the imaging unit 11 to capture an image by blocking the light directed from the bottom side toward the top side in the top-bottom direction with respect to the injection molding product 100. The underlay member 17 does not necessarily need to be disposed as long as the above-described support member 15 includes a member having the same light-blocking function as that of the underlay member 17.

### Conveying Device 20

The conveying device 20 is a device as conveying means for conveying the injection molding product 100 serving as the inspection object toward the imaging device 10. For example, as illustrated in FIG. 1, the conveying device 20 includes a belt conveyor or the like that can place and convey the injection molding product 100 from the left side to the right side in the left-right direction in FIG. 1. An injection molding machine (not illustrated) is installed on an upstream side (left side in the left-right direction in FIG. 1) of the conveying device 20. The imaging device 10 is installed on a downstream side (right side in the left-right direction in FIG. 1) of the conveying device 20. Therefore, the injection molding product 100 molded by the injection molding machine is conveyed toward the imaging device 10 in a state of being placed on the conveying device 20.

### Picking Device 30

The picking device 30 is a device used as picking means for gripping the injection molding product 100 to move the injection molding product 100 to a predetermined location. For example, as illustrated in FIG. 1, the picking device 30 includes a so-called picking robot or the like. An end effector 32 capable of gripping the injection molding product 100 is mounted on the picking device 30. The picking device 30 grips and releases the injection molding product 100 by using the end effector 32.

In this manner, the picking device 30 moves the injection molding product 100 to the predetermined location. Specifically, the picking device 30 performs an operation for gripping the injection molding product 100 placed on the conveying device 20 and releasing the injection molding product 100 on the underlay member 17. Thereafter, when the injection molding product 100 is imaged by the imaging unit 11, the picking device 30 grips the imaged injection molding product 100 again, moves the injection molding product 100 to a predetermined position, and releases the injection molding product 100.

### Control Device 40

The control device 40 is an information processing device as control means for controlling an operation of the imaging device 10. Specifically, the control device 40 controls operations of the imaging unit 11, the irradiation unit 12, and the light-blocking member 13 of the imaging device 10. The control device 40 includes a personal computer, a tablet terminal, a smartphone, or the like, and can be operated by a user.

For example, the control device 40 controls an amount, an angle, a position, and the like of the light emitted to irradiate the injection molding product 100 by performing control for changing the position of the cutout portion 132 serving as the light transmission region in the light-blocking member 13. Specifically, the control device 40 controls an operation of the light-blocking member 13 rotating in the circumferential direction, as control for changing the position of the cutout portion 132.

In addition, for example, the control device 40 controls an operation of the imaging unit 11 to image the injection molding product 100 serving as the inspection object, controls an operation of the irradiation unit 12 to irradiate the injection molding product 100 with the light, and controls an operation of the irradiation unit 12 to move in the top-bottom direction. In addition, the control device 40 controls an operation of the light-blocking member 13 to move in the top-bottom direction. In addition, in addition to controlling the operation of the imaging device 10, the control device 40 controls a process of determining whether or not the injection molding product 100 has a defect by analyzing the captured image of the injection molding product 100 imaged by the imaging unit 11 of the imaging device 10. Furthermore, when at least one of the conveying device 20 and the picking device 30 is connected to the network 90, the control device 40 may control the operation of the conveying device 20 or the operation of the picking device 30 via the network 90.

### Specific Example of Shape of irradiation Unit 12 and Light-Blocking Member 13

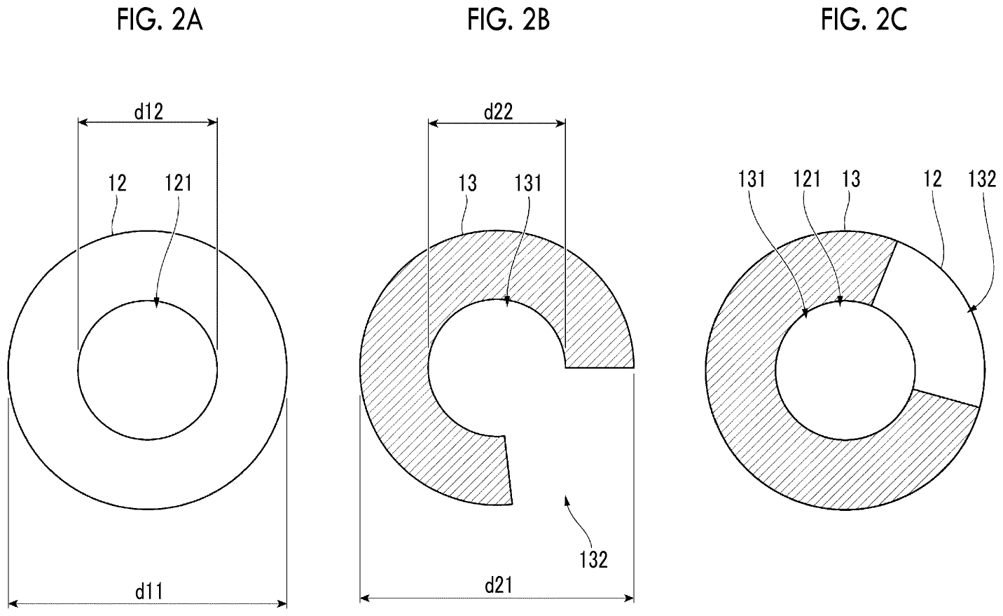

FIGS. 2A to 2C are diagrams illustrating specific examples of the shapes of the irradiation unit 12 and the light-blocking member 13. FIG. 2A illustrates a specific example of the shape of the irradiation unit 12. FIG. 2B illustrates a specific example of the shape of the light-blocking member 13. FIG. 2C illustrates an example of a state of the irradiation unit 12 and the light-blocking member 13 when the top side in the top-bottom direction is viewed from a side of the injection molding product 100 placed on the underlay member 17 as the inspection object.

As illustrated in FIG. 2A, the shape of the irradiation unit 12 when viewed in the top-bottom direction is an annular shape having the penetrating portion 121 in a central portion. In addition, as illustrated in FIG. 2B, the shape of the light-blocking member 13 when viewed in the top-bottom direction is a substantially annular shape having the cutout portion 132, and a substantially circular space 131 is formed in the central portion. The cutout portion 132 forms the light transmission region that transmits the light emitted from the irradiation unit 12.

In an example illustrated in FIGS. 2A and 2B, a diameter d11 of the irradiation unit 12 and a diameter d21 of the light-blocking member 13 are the same or substantially the same as each other. In addition, a diameter d12 of the penetrating portion 121 of the irradiation unit 12 and a diameter d22 of the space 131 of the light-blocking member 13 are the same or substantially the same as each other. However, the present invention is not limited thereto. The light-blocking member 13 may block light other than the light transmitted through the cutout portion 132 in the light emitted to irradiate the inspection object from the irradiation unit 12 without any leakage, and, for example, the diameter d21 of the light-blocking member 13 may be larger than the diameter d11 of the irradiation unit 12. In addition, for the same reason, the diameter d12 of the penetrating portion 121 of the irradiation unit 12 may be larger than the diameter d22 of the space 131 of the light-blocking member 13. When the inspection object is disposed in the penetrating portion 121 of the irradiation unit 12 and the space 131 of the light-blocking member 13, the diameter d22 of the space 131 is formed in view of a size that allows the inspection object to be accommodated.

The light-blocking member 13 illustrated in FIG. 2B is rotatable in the circumferential direction, and the position of the cutout portion 132 is changed by the light-blocking member 13 rotating in the circumferential direction. For example, the irradiation unit 12 illustrated in FIG. 2A and the light-blocking member 13 illustrated in FIG. 2B are disposed to overlap each other, and the light-blocking member 13 is rotated in the circumferential direction. In this manner, the cutout portion 132 can be disposed at a position illustrated in FIG. 2C. In this case, a region of the light-blocking member 13 hatched in the drawing forms a light-blocking region that blocks the light emitted from the irradiation unit 12, and a region of the cutout portion 132 where the irradiation unit 12 is exposed forms a light transmission region that transmits the light emitted from the irradiation unit 12.

### Specific Example of Imaging Method During Internal Inspection

FIG. 3 is a diagram illustrating a specific example of an imaging method during an internal inspection for the inspection object.

FIG. 1 described above illustrates an example of an imaging method in which a defect of the injection molding product 100 is emphasized by irradiating the injection molding product 100 with the light from the top side in the top-bottom direction during a surface inspection for the injection molding product 100 having a flat plate shape which is a transparent or semi-transparent inspection object. In contrast, when the inspection object has a long shape in the top-bottom direction and is configured such that an injection molding product 110 is accommodated in each of the penetrating portion 121 of the irradiation unit 12 and the space 131 of the light-blocking member 13, for example, as illustrated in FIG. 3, an imaging method is adopted as the internal inspection for the transparent or semi-transparent inspection object.

That is, as illustrated in FIG. 3, the irradiation unit 12 irradiates the injection molding product 110 with the light from a periphery of the injection molding product 110 in a state where the injection molding product 110 serving as the inspection object is disposed in the penetrating portion 121. Specifically, first, as the light irradiation from a so-called low angle, the irradiation unit 12 irradiates the injection molding product 110 with the light while the vicinity of an end portion of the bottom side in the top-bottom direction of the injection molding product 110 is set as an irradiation position. In this manner, it is possible to emphasize and display a defect occurring inside the transparent or semi-transparent injection molding product 110.

Next, the irradiation unit 12 moves toward the top side in the top-bottom direction to move the irradiation position of the light with respect to the injection molding product 110. The injection molding product 110 is imaged by the imaging unit 11 while the irradiation unit 12 moves in the top-bottom direction or while the irradiation unit 12 is temporarily stopped.

As described above, the light-blocking member 13 can move in the top-bottom direction in conjunction with the movement of the irradiation unit 12 in the top-bottom direction. However, the light-blocking member 13 is a member that exhibits a light-blocking function by being disposed between the irradiation unit 12 and the inspection object during the surface inspection for the inspection object, and basically does not exhibit the light-blocking function due to a positional relationship with the irradiation unit 12 during the internal inspection for the inspection object. Therefore, for example, the light-blocking member 13 may be disposed on the bottom side of the irradiation unit 12 in the top-bottom direction only during the surface inspection for the inspection object. For example, a drive unit that rotates and moves the whole light-blocking member 13 in a direction perpendicular to the top-bottom direction may be provided in the support member 14 that supports the light-blocking member 13.

### Modification Example

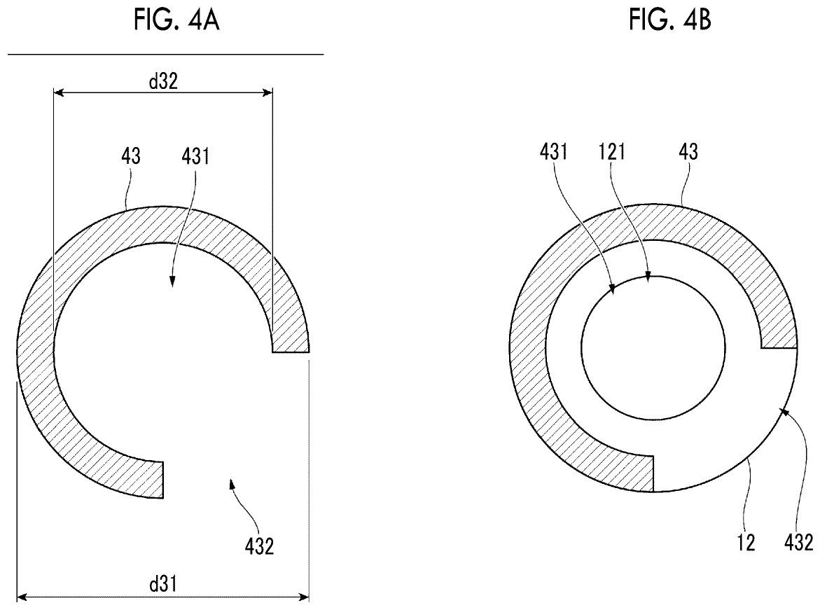

FIGS. 4A and 4B are diagrams illustrating a modification example of the light-blocking member. FIG. 4A illustrates a specific example of the shape of a light-blocking member 43 which is a modification example. FIG. 4B illustrates a state of the irradiation unit 12 and the light-blocking member 43 when the top side in the top-bottom direction is viewed from the side of the inspection object placed on the underlay member 17 (refer to FIG. 1).

The light-blocking member 43 illustrated in FIG. 4A has a substantially annular shape having a cutout portion 432, as in the light-blocking member 13 illustrated in FIG. 2B described above, and a substantially circular space 431 is formed in the central portion. As illustrated in FIG. 4B, the cutout portion 432 forms the light transmission region that transmits the light emitted from the irradiation unit 12.

A difference between the light-blocking member 43 illustrated in FIGS. 4A and 4B and the light-blocking member 13 illustrated in FIG. 2B described above is the size of the diameter of the substantially circular space formed in the central portion. That is, a diameter d31 of the light-blocking member 43 and the diameter d21 (refer to FIG. 2B) of the light-blocking member 13 are the same or substantially the same as each other. However, a diameter d32 of the space 431 of the light-blocking member 43 is larger than the diameter d22 of the space 131 of the light-blocking member 13 in FIG. 2B described above. In this manner, as illustrated in FIG. 4B, a region of the light-blocking member 43 hatched in the drawing forms the light-blocking region that blocks the light emitted from the irradiation unit 12. In addition, a region of the cutout portion 432 and a region of the space 431 where the irradiation unit 12 is exposed form the light transmission region that transmits the light emitted from the irradiation unit 12.

Since the light transmission region illustrated in FIG. 4B is wider than the light transmission region illustrated in FIG. 2C described above, the amount of the light emitted to irradiate the inspection object increases accordingly. As a result, a defect of the inspection object is more easily emphasized and displayed. However, as the light-blocking region is narrower, there is a high risk of an appearance of the light reflected on the inspection object or an appearance of the irradiation unit 12 projected onto the inspection object. Therefore, at an inspection site, various types of the light-blocking members which can more easily emphasize and display the defect and which can suppress the appearance depending on a type of the inspection objects are prepared to be selectable. In this manner, a simpler method can be realized to suppress the appearance of the light reflected on the inspection object and the appearance of the irradiation unit 12 itself projected onto the inspection object when the inspection object is imaged, compared to when a plurality of light sources having different irradiation angles are provided to image the inspection object.

In summary of the above-described configurations, the inspection assistance system 1 of the present embodiment of the present invention can adopt various embodiments as long as the following configurations are adopted.

That is, the inspection assistance system 1 according to the present embodiment is the inspection assistance system including the imaging unit 11 as the imaging means for imaging the injection molding product 100 serving as the inspection object, the irradiation unit 12 as the irradiation means disposed between the imaging unit 11 and the injection molding product 100 to irradiate the injection molding product 100 with the light, the light-blocking member 13 as the light-blocking means disposed between the irradiation unit 12 and the injection molding product 100 and including the light-blocking region that blocks the light emitted from the irradiation unit 12 and the cutout portion 132 as the light transmission region that transmits the light emitted from the irradiation unit 12, and the control device 40 as the irradiation light control means for controlling the light emitted to irradiate the injection molding product 100 by changing the position of the cutout portion 132 in the light-blocking member 13.

In this manner, the imaging unit 11, the irradiation unit 12, the light-blocking member 13, and the injection molding product 100 serving as the inspection object are disposed in this order from the top side toward the bottom side in the top-bottom direction. The position of the cutout portion 132 serving as the light transmission region of the light-blocking member 13 is changed. Accordingly, the light emitted to irradiate the injection molding product 100 is controlled. As a result, a simpler method can be realized to suppress the appearance of the light reflected on the inspection object and the appearance of the irradiation unit 12 itself projected onto the injection molding product 100 when the injection molding product 100 is imaged, compared to when the plurality of light sources having different irradiation angles are provided to image the injection molding product 100.

Here, the light-blocking member 13 may include one or the plurality of cutout portions 132 or through-holes serving as the light transmission regions.

In this manner, one or the plurality of cutout portions 132 or through-holes serving as the light transmission regions are formed in the light-blocking member 13. As a result, since the position of one or the plurality of cutout portions 132 or through-holes formed in the light-blocking member 13 is changed, the light emitted to irradiate the injection molding product 100 serving as the inspection object is controlled.

In addition, the irradiation unit 12 may have an annular shape when viewed from the injection molding product 100, and the light-blocking member 13 may be an annular member provided with the cutout portion 132, which has the same or substantially the same shape as the irradiation unit 12.

In this manner, the position of the cutout portion 132 of the light-blocking member 13 in which the cutout portion 132 is formed in the annular member which has the same or substantially the same shape as the irradiation unit 12 having the annular shape when viewed from the injection molding product 100 serving as the inspection object is changed. Accordingly, the light emitted to irradiate the injection molding product 100 is controlled.

In addition, the light-blocking member 13 may rotate in the circumferential direction to change the position of the cutout portion 132.

In this manner, the position of the cutout portion 132 is changed only by rotating the light-blocking member 13 in the circumferential direction. As a result, it is possible to control the light emitted to irradiate various types of the inspection objects.

In addition, at least one of the irradiation unit 12 and the light-blocking member 13 may be movable in the axial direction.

In this manner, at least one of the irradiation unit 12 and the light-blocking member 13 moves in the axial direction. As a result, it is possible to control the light emitted to irradiate various types of the inspection objects (for example, the injection molding product 110 in FIG. 3).

In addition, the inspection object may be the transparent or semi-transparent injection molding product 100.

In this manner, a simpler method can be realized to suppress the appearance of the light reflected on the injection molding product 100 and the appearance of the irradiation unit 12 itself projected onto the injection molding product 100 when the transparent or semi-transparent injection molding product 100 serving as the inspection object is imaged, compared to when the plurality of light sources having different irradiation angles are provided to image the injection molding product 100.

In addition, the inspection assistance method according to the present embodiment includes a step of causing the imaging unit 11 to image the injection molding product 100 serving as the inspection object, a step of causing the irradiation unit 12 disposed between the imaging unit 11 and the injection molding product 100 to irradiate the injection molding product 100 with the light, a step of causing the light-blocking region of the light-blocking member 13 disposed between the irradiation unit 12 and the injection molding product 100 to block the light emitted from the irradiation unit 12 and causing the cutout portion 132 serving as the light transmission region of the light-blocking member 13 to transmit the light emitted from the irradiation unit 12, and a step of causing the control device 40 serving as the irradiation light control means to control the light emitted to irradiate the injection molding product 100 by changing the position of the light transmission region in the light-blocking member 13.

In this manner, the imaging unit 11, the irradiation unit 12, the light-blocking member 13, and the injection molding product 100 serving as the inspection object are disposed in this order from the top side toward the bottom side in the top-bottom direction. The position of the cutout portion 132 serving as the light transmission region of the light-blocking member 13 is changed. Accordingly, the light emitted to irradiate the injection molding product 100 is controlled. As a result, a simpler method can be realized to suppress the appearance of the light reflected on the injection molding product 100 and the appearance of the irradiation unit 12 itself projected onto the injection molding product 100 when the injection molding product 100 is imaged, compared to when the plurality of light sources having different irradiation angles are provided to image the injection molding product 100.

### Other

In the above-described embodiment, the control device 40 in FIG. 1 functions as control means for controlling the operation of the imaging device 10, and controls each operation of the imaging unit 11, the irradiation unit 12, and the light-blocking member 13 of the imaging device 10. However, the present invention is not limited thereto. Each operation of the imaging unit 11, the irradiation unit 12, and the light-blocking member 13 of the imaging device 10 does not necessarily need to be controlled by an information processing device such as the control device 40. For example, at least some control of the operation of the imaging device 10 may be manually performed by a worker. Specifically, the operation for rotating the light-blocking member 13 in the circumferential direction may be manually performed by the worker.

In addition, the inspection objects of the inspection assistance system 1 according to the above-described embodiment are the transparent or semi-transparent injection molding products 100 and 110. However, the inspection objects are not limited to the transparent or semi-transparent injection molding products. The inspection object may be an opaque injection molding product, a transparent or semi-transparent object other than the injection molding product, or an opaque object other than the injection molding product.

In addition, the shape of the irradiation unit 12 and the shape of the light-blocking member 13 according to the above-described embodiment are examples, and may be other shapes. As described above, as the light-blocking member 13, various types in which the defect is more easily emphasized and displayed and the appearance can be suppressed in accordance with the type of the inspection object can be prepared in advance. For example, the light-blocking member 13 according to the above-described embodiment includes the cutout portion 132 serving as the light transmission region. However, the light-blocking member 13 does not necessarily need to be the cutout portion. For example, a region formed by the through-hole penetrating a portion of the light-blocking member 13 in the top-bottom direction may be used as the light transmission region.

In addition, although there is provided one cutout portion 132 serving as the light transmission region formed in the light-blocking member 13 according to the above-described embodiment, the number of the light transmission regions is not limited to one. One or a plurality of light transmission regions can be formed in the light-blocking member 13. For example, two or more cutout portions 132 may be formed in the light-blocking member 13 in FIG. 2B described above.

In addition, in the above-described embodiment, the substantially annular light-blocking member 13 having the cutout portion 132 rotates in the circumferential direction to change the position of the cutout portion 132. However, the configuration is not limited thereto. For example, a shutter mechanism that is openable and closable may be provided in the light-blocking member 13 so that each of the one or the plurality of light transmission regions is visible or hidden. That is, the light-blocking member 13 may have the plurality of light transmission regions that enable switching between an exposed state and a non-exposed state.

In this manner, the light-blocking member 13 includes the plurality of light transmission regions that enable switching between the exposed state and the non-exposed state. Therefore, it is possible to control the light emitted to irradiate various types of the inspection objects.

### Specific Example of Captured Image on Which Illumination Tool Itself Appears

FIG. 5 is a diagram illustrating an example in which the illumination tool is projected onto the inspection object and appears on a captured image when the inspection object is imaged.

As an example of a case where the present invention is not applied, FIG. 5 illustrates an example of a captured image when the inspection object is imaged without disposing the light-blocking member 13 according to the above-described embodiment. In the example illustrated in FIG. 5, eight captured images captured by irradiating the injection molding product 100 serving as the inspection object with the light of the illumination tool at different irradiation angles are illustrated.

In each of the eight captured images illustrated in FIG. 5, the illumination tool projected onto the inspection object appears in a region surrounded by a broken line, thereby hindering the inspection. In contrast, according to the inspection assistance system 1 (refer to FIG. 1) in the above-described embodiment, the position of the cutout portion 132 is changed by rotating the light-blocking member 13 (refer to FIG. 2C). In this manner, the position of the light transmission region can be changed. Therefore, the appearance as illustrated in FIG. 5 can be suppressed.

It should be understood that the invention is not limited to the above-described embodiment, but may be modified into various forms on the basis of the spirit of the invention. Additionally, the modifications are included in the scope of the invention.

What is claimed is:

1. An inspection assistance system comprising:
an imaging unit configured to image an inspection object;
an irradiation unit disposed between the imaging unit and the inspection object to irradiate the inspection object with light;
a light-blocking unit disposed between the irradiation unit and the inspection object and having a light-blocking region that blocks the light and a light transmission region that transmits the light; and
an irradiation light control unit configured to control the light emitted to irradiate the inspection object by changing a position of the light transmission region in the light-blocking unit.

2. The inspection assistance system according to claim 1, further comprising:
a conveying device configured to convey the inspection object;
a picking device configured to grip and move the inspection object; and
a control device configured to determine whether or not the inspection object has a defect.

3. The inspection assistance system according to claim 2,
wherein the conveying device includes a belt conveyor configured to place and convey the inspection object from an upstream side to a downstream side.

4. The inspection assistance system according to claim 2,
wherein an end effector configured to grip the inspection object is mounted on the picking device.

5. The inspection assistance system according to claim 2,
wherein the control device includes a personal computer, a tablet terminal, or a smartphone, and is operable by a user, and
the control device controls operations of the imaging unit, the irradiation unit, and the light-blocking unit.

6. The inspection assistance system according to claim 1,
wherein the light-blocking unit includes one or a plurality of cutout portions or penetrating portions as the light transmission region.

7. The inspection assistance system according to claim 1,
wherein the irradiation unit has a substantially annular shape when viewed from the inspection object, and
the light-blocking unit is a substantially annular member provided with the light transmission region, which has the same or substantially the same shape as the irradiation unit.

8. The inspection assistance system according to claim 7,
wherein the light-blocking unit rotates in a circumferential direction to change the position of the light transmission region.

9. The inspection assistance system according to claim 8,
wherein at least one of the irradiation unit and the light-blocking unit is movable in an axial direction.

10. The inspection assistance system according to claim 1,
wherein the light-blocking unit includes the light transmission region and one or more additional light transmission regions that enable switching between an exposed state and a non-exposed state.

11. The inspection assistance system according to claim 1,
wherein the inspection object is a transparent or semi-transparent injection molding product.

12. An inspection assistance method comprising:
a step of causing an imaging unit to image an inspection object;
a step of causing an irradiation unit disposed between the imaging unit and the inspection object to irradiate the inspection object with light;
a step of causing a light-blocking region of a light-blocking unit disposed between the irradiation unit and the inspection object to block the light and causing a light transmission region of the light-blocking unit to transmit the light; and
a step of causing an irradiation light control unit to control the light emitted to irradiate the inspection object by changing a position of the light transmission region in the light-blocking unit.
